(19) United States
(12) Patent Application Publication
(10) Pub. No.: US 2026/0318059 A1
(43) Pub. Date: Oct. 15, 2026

(54) MOULD FOR PRODUCING A LOWER SHAFT PART FROM CONCRETE

(71) Applicant: Ulrich Schlüsselbauer, Altenhof am Hausruck (AT)

(72) Inventor: Ulrich Schlüsselbauer, Altenhof am Hausruck (AT)

(21) Appl. No.: 19/482,849

(22) PCT Filed: May 6, 2024
(86) PCT No.: PCT/AT2024/060190

§ 371 Date: Nov. 10, 2025

(30) Foreign Application Priority Data
May 9, 2023 (AT) A 50359/2023

(51) Int. Cl. E03F 3/04; E03F 1/00

(52) U.S. Cl. CPC E03F 3/04; E03F 1/00

(57) ABSTRACT

A device for manufacturing a concrete lower shaft part comprising a shaft floor (1) with a channel (2) and a shaft shell (3) rising from the shaft floor (1) includes a moulding tool consisting of a split mould shell (4) that can be opened for demoulding the lower shaft part (4) and a mould core (5) that carries a mould body (9) forming the negative mould of the channel (2), and block-out bodies (12) of hard foam material attached to this mould body (9) and adjoining the mould shell (4) for forming pipe connections (11) for the channel (2). The block-out bodies (12) form a circumferential peripheral ridge (15) that protrudes against the mould shell (4) by an extended height (h) and that, when the mould shell (4) is closed, lies tightly against the mould shell (4) under deformation.

### FIELD OF THE INVENTION

The invention relates to a device for manufacturing a concrete lower shaft part comprising a shaft floor with a channel and a shaft shell rising from the shaft floor, with a moulding tool consisting of a split mould shell that can be opened to remove the moulded lower shaft part and a mould core, which carries a mould body forming the negative mould of the channel and which mould core carries block-out bodies made of hard foam material attached to this mould body and adjoining the mould shell for forming pipe connections for the channel.

### DESCRIPTION OF THE PRIOR ART

In order to adapt the channel branches of a lower shaft part to the local conditions of a construction site, it is known (AT 500 886 B1, WO 2004/091877 A1) to detachably attach a mould body to the floor surface of the mould core of a moulding tool, which forms the stepping surface of the shaft floor, to produce the negative mould of the respective channel. This mould body is composed of straight and arc-shaped profile pieces for the individual channel branches. By selecting the appropriate arc radius for the curved threaded branches, the mould body can always be assembled from individual, appropriately cut straight and circular arc-shaped profile pieces in such a way that the sewage pipes, which are fixed in position, are well connected in terms of flow to the channels of a lower shaft part produced with the aid of such a moulding tool.

To connect the sewage pipes to the channel of a lower shaft part, block-out bodies are provided on the free end faces of the profile pieces to form pipe connections in the shaft shell for the individual channel branches (DE 19540454 A1, DE 10317321 A1, U.S. Pat. No. 4,427,619 A). After the split mould shell has been closed, these block-out bodies are intended to fit tightly against the mould shell so that concrete particles cannot penetrate any gaps between the block-out bodies and the mould shell, which would impair the edge formation of the sleeve-type pipe connections and thus necessitate costly reworking of the pipe connections. However, due to unavoidable manufacturing tolerances, this is only achieved to an insufficient degree.

If ring-shaped block-out bodies are used instead of block-out bodies made of hard foam (U.S. Pat. No. 5,413,307 A, CA 1028482 A), the dependence of the tight connection of these block-out bodies to the mould shell on manufacturing tolerances does not change due to the ring shape. If the ring-shaped block-out bodies are clamped either to the mould core or to the mould shell using a clamping screw that passes through the mould core or mould shell (CA 1028482 A), this results in the additional disadvantage that a mould wall must be provided with through holes for the clamping screws.

In the case of two-part, ring-shaped block-out bodies, in which one ring part forms a permanent mould adjoining the mould core, while the other, complementary ring part, tightly fitted to the peripheral wall of the permanent mould, adjoins the mould shell (DE 20206323 U1, U.S. Pat. No. 6,450,505 B1), the tightness of the connection between the complementary ring part and the mould shell is again determined by the manufacturing tolerances of this ring part.

Similar conditions arise when the ring-shaped block-out bodies are composed of two mould rings between which a ring seal that can be poured into the concrete body is held (U.S. Pat. Nos. 4,685,650 A, 6,347,781 B1), because the design of the mould rings in the connection area to the mould walls again has a decisive influence on the tightness.

Finally, for casting concrete walls with a textured surface, it is known (U.S. Pat. No. 3,148,433 A) to attach mould shells that determine the surface texture to a mould wall. These mould shells, which are made of sheet metal, are fastened to the mould wall with a snap-lock type fastener that passes through the mould wall, whereby the shell edges are provided with a separate seal running around the edge to ensure a tight connection between the mould shells and the mould wall, which involves considerable construction effort, especially since the ring groove accommodating the ring seal is formed between the peripheral wall of the mould shell and an additional sheet metal ring resting against the inner side of the peripheral wall, which precludes application to a block-out body made of rigid foam. In addition, it is necessary to provide through holes in the mould wall for the fastening anchors, which limits the use of such moulds to a wall design.

### SUMMARY OF THE INVENTION

The invention is therefore based on the task of designing a device for manufacturing a concrete lower shaft part in such a way that, despite unavoidable manufacturing tolerances, it can be ensured by simple means that the block-out bodies provided for forming the pipe connections on the free end faces of the mould body for the channel lie close to the closed mould shell.

Based on a device of the type described at the outset, the invention solves the task set by means of the block-out bodies forming a circumferential peripheral ridge which projects towards the mould shell by way of an extended height and, when the mould shell is closed, bears tightly to the mould shell under deformation.

By providing a circumferential peripheral ridge of the block-out bodies that projects towards the mould shell by an extended height, it is achieved that, when the mould shell is closed, the mould shell is pressed against the peripheral ridge under deformation of the peripheral ridge, so that with the extended height being selected accordingly the entire range of manufacturing tolerances can be compensated. The fact that the block-out bodies only rest against the mould shell along a protruding peripheral ridge limits the deformation resistance of the block-out bodies made of rigid foam that must be overcome for the deformation of the peripheral ridge, so that the pressures to be applied to the peripheral ridges via the mould shell for their deformation can be applied without difficulty by the closing forces of the mould shell. The deformation of the peripheral ridges caused by their excess dimension when the mould shell is closed, which will usually extend beyond the elastic range into the plastic range, ensures that the peripheral ridges rest against the mould shell under a preload, whereby the sealing effect can also be ensured during rough manufacturing conditions, such as those that occur when using vibration drives for the moulding tool.

With regard to the deformation of the peripheral ridges, particularly advantageous conditions arise when the peripheral ridge of the block-out bodies tapers in cross-section towards the mould shell by means of a conical inner surface. Due to the resulting weakening of the ridge cross-section radially outwards, the peripheral ridge is deformed radially outwards under material displacement when the mould shell is closed, with the effect that the outer circumferential edge of the pipe connections to be produced is provided with a run-in chamfer, which otherwise can hardly be manufactured without an additional manufacturing step.

### BRIEF DESCRIPTION OF THE INVENTION

The drawing shows an example of the subject matter of the invention, wherein

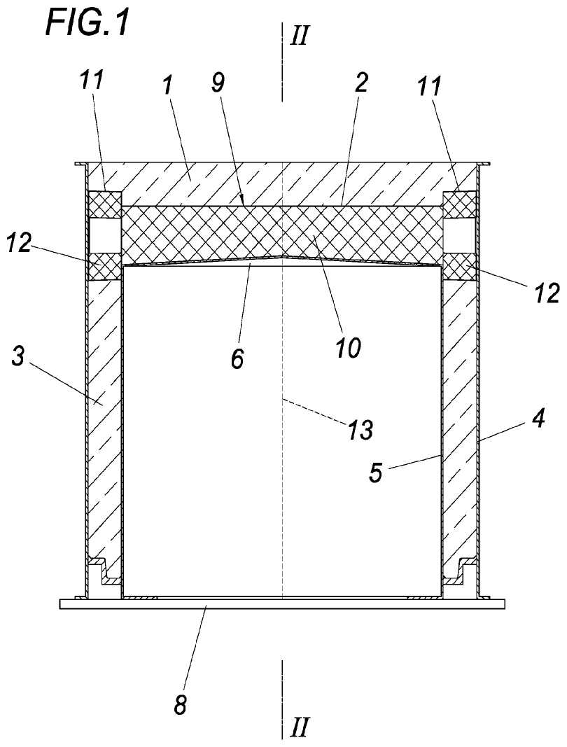

FIG. 1 shows a device according to the invention for manufacturing a concrete lower shaft part in a simplified axial section,

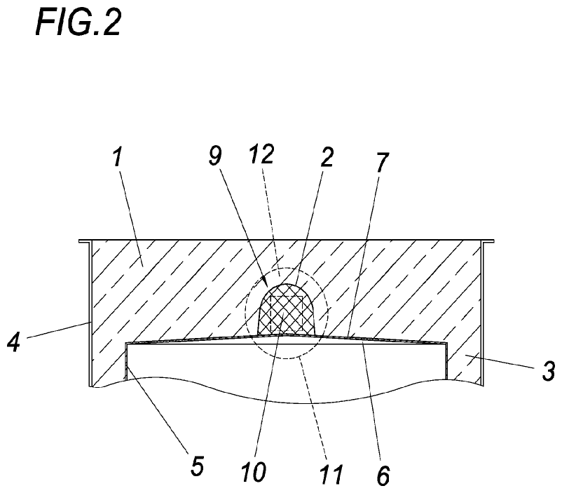

FIG. 2 shows a section along line II-II of FIG. 1,

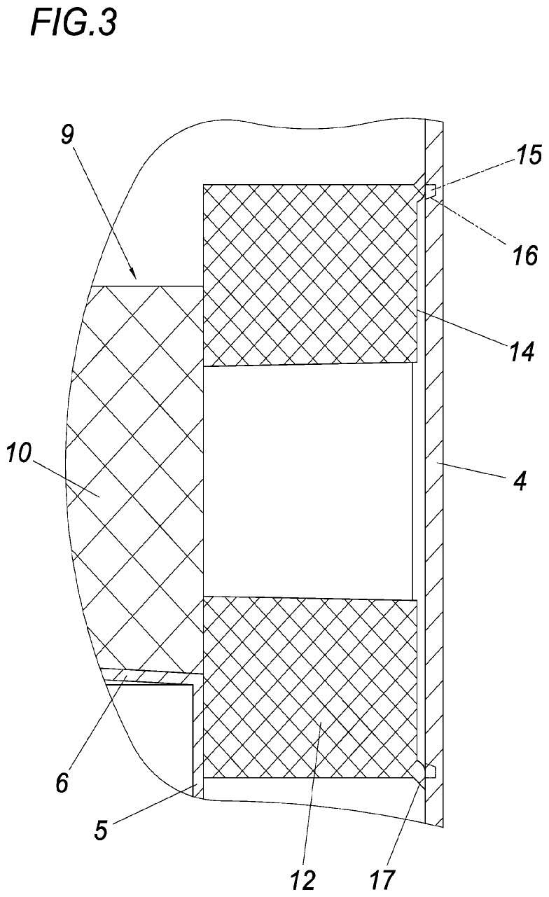

FIG. 3 shows the device in an axial section according to FIG. 1, shown in detail in the area of block-out bodies with the mould shell closed, on a larger scale,

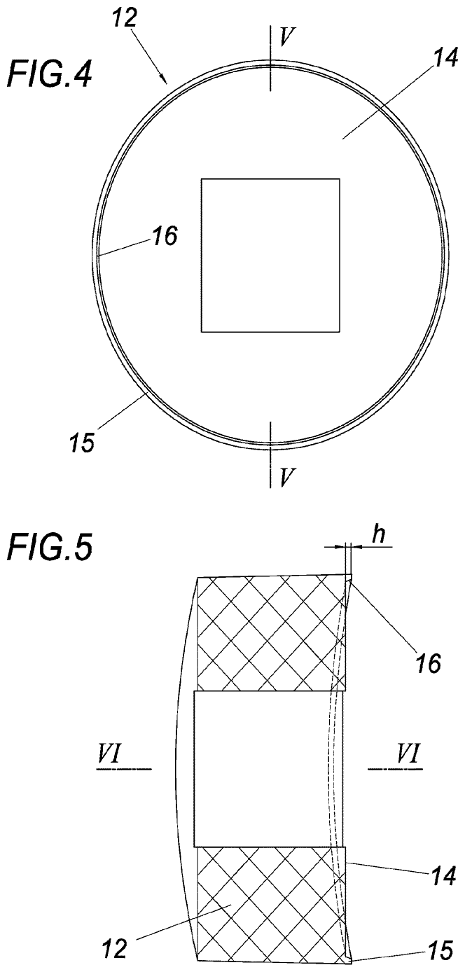

FIG. 4 shows block-out bodies in a simplified front view on a larger scale,

FIG. 5 shows the block-out bodies according to FIG. 4 in a section along line V-V of FIG. 4, and

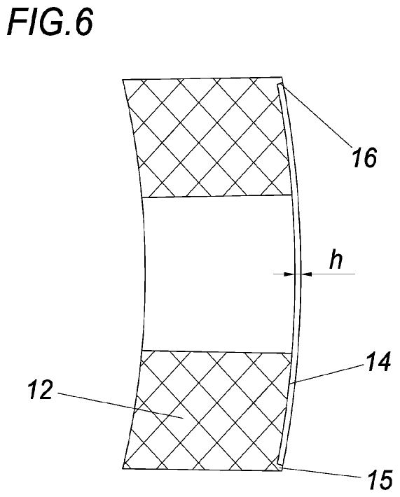

FIG. 6 shows the block-out bodies in a section along line VI-VI of FIG. 5.

### DESCRIPTION OF THE PREFERRED EMBODIMENTS

For manufacturing a concrete lower shaft part comprising a shaft floor 1 with a channel 2 and a shaft shell 3 rising from the shaft floor 1, a moulding tool is provided which consists of a split mould shell 4 and a mould core 5 coaxial thereto, which is pot-shaped and forms a conical base 6 for moulding a stepping surface 7 of the lower shaft part. The mould core 5 and the split mould shell 4 are arranged on a frame-like support structure 8, which can be coupled to a turning device in order to be able to demould the lower shaft part, which is produced, for example, in a vibratory pressing process, before it hardens. However, it is of course also possible to cast the lower shaft part with wet concrete, which requires the lower shaft part to be cured accordingly before it is removed from the mould.

To form the channel 2, which connects the sewage pipes to be connected to the lower shaft part, a mould body 9 forming the negative mould of the channel 2 is assembled from straight and/or curved, preferably arc-shaped profile pieces 10 made of hard foam, which form the individual channel branches. In the embodiment shown, for the sake of simplicity, the channel 2 comprises only a straight main branch connecting an inlet pipe to an outlet pipe. For the sewage pipes to be connected to the lower shaft part, socket-like pipe connections 11 must be provided in the shaft shell 3, for the formation of which pipe connections 11 block-out bodies 12, also made of hard foam, are tightly fitted to the free end faces of the mould body 9. When the mould shell 4 is closed, the block-out bodies 12, whose axial dividing plane 13 is indicated by a dotted line in FIG. 1, fit against the mould shell 4 so that the respective pipe connections 11 in the lower shaft part to be manufactured are formed by these block-out bodies 12.

FIGS. 4 to 6 show block-out bodies 12, which, for reasons of clarity, are shown in a simple, circular cylindrical shape, but this is by no means mandatory. The block-out bodies 12 must correspond to the design specifications and form a negative image of the pipe connections 11, whereby it is also possible to attach sealing rings to the block-out bodies 12, which are cast into the shaft wall 3 in the area of the pipe connections 11.

Block-out bodies 12 according to the invention have a circumferential peripheral ridge 15 on the cylindrical end face 14 facing the mould shell 4, which protrudes against the mould shell 4 and has a height h that is extended to an oversize so that when the mould shell 4 is closed, the peripheral ridge 15 is compressed in height by the mould shell 4, as can be seen in FIG. 3. This means that when the moulding tool is closed, the peripheral ridge 15 is held pressed against the mould shell 4 under a preload and therefore the block-out bodies 12 fit tightly against the mould shell 4 regardless of any manufacturing tolerances.

Since the peripheral ridge 15 preferably tapers in cross-section towards the mould shell 4, namely by means of a conical inner surface 16 which opens radially outwards, i.e. towards the mould shell 4, the peripheral ridge 15 is deformed radially outwards with the effect that the deformed outer surface 17 of the peripheral ridge enables the formation of an edge chamfer of the sleeve-type pipe connection 11.

1. A device for manufacturing a concrete lower shaft part comprising a shaft floor with a channel and a shaft shell rising from the shaft floor said device comprising:
a moulding tool having a split mould shell configured to be opened so as to to permit removal of a moulded shaft base and a mould core, which carries a mould body forming a negative mould of the channel and
wherein said mould core carries block-out bodies of hard foam material attached to the mould body and adjoining the mould shell so as to form pipe connections configured to be connected to the channel;
wherein the block-out bodies form an encircling peripheral ridge that projects towards the mould shell by an extended height and, when the mould shell is closed, is deformed so that the peripheral ridge bears tightly against the mould shell.

2. The device according to claim 1, wherein the peripheral ridge of the block-out bodies tapers in cross-section towards the mould shell with a conical inner surface.
